(19) United States
(12) Patent Application Publication
(10) Pub. No.: US 2026/0018677 A1
(43) Pub. Date: Jan. 15, 2026

(54) LITHIUM SECONDARY BATTERY

(71) Applicant: NGK INSULATORS, LTD., Nagoya-shi (JP)

(72) Inventors: Mikako IWAHANA, Nagoya-shi (JP); Daisuke IIDA, Nagoya-shi (JP); Eiji NAKASHIMA, Nagoya-shi (JP)

(21) Appl. No.: 19/333,204

(22) Filed: Sep. 18, 2025

Related U.S. Application Data
(63) Continuation of application No. PCT/JP2024/011273, filed on Mar. 22, 2024.

(30) Foreign Application Priority Data
Mar. 30, 2023 (JP) 2023-056460

(51) Int. Cl. H01M 10/0585; H01M 4/70; H01M 10/052; H01M 10/0569; H01M 50/105; H01M 50/486

(52) U.S. Cl. CPC H01M 10/0585; H01M 4/70; H01M 10/052; H01M 10/0569; H01M 50/105; H01M 50/486; H01M 2300/0037

(57) ABSTRACT

A lithium secondary battery includes a positive electrode layer composed of a sintered body of lithium complex oxide, a negative electrode layer, a separator interposed between the positive electrode layer and the negative electrode layer, an electrolytic solution containing an electrolyte and a solvent and impregnated into the positive electrode layer, the negative electrode layer, and the separator, and an exterior body including a closed space in which the positive electrode layer, the negative electrode layer, the separator, and the electrolytic solution are accommodated. In a thickness direction of the positive electrode layer, a ratio of a thickness of the exterior body at a temperature of 80° C. and a pressure of 100 Pa to a thickness of the exterior body at a temperature of 25° C. and a pressure of 101325 Pa is 1.05 or more and 2.63 or less.

### CROSS-REFERENCE TO RELATED APPLICATION

This application is a continuation application of PCT/JP2024/011273, filed on Mar. 22, 2024, which claims the benefit of priority of Japanese Application No. 2023-056460, filed on Mar. 30, 2023, the entire contents of which are incorporated herein by reference.

### TECHNICAL FIELD

The present disclosure relates to a lithium secondary battery. The present application claims priority based on Japanese Patent Application No. 2023-056460 filed on Mar. 30, 2023, the entire contents of which are incorporated herein by reference.

### BACKGROUND ART

A technique related to a pouch-type lithium secondary battery is disclosed, for example, in Japanese Patent Application Laid-Open No. 2017-79192 (Patent Literature 1). As a positive electrode active material in a lithium secondary battery (also called a lithium ion secondary battery), there is conventionally known a powder-dispersed positive electrode active material, which is obtained by forming a kneaded mixture of lithium complex oxide (i.e., lithium transition metal oxide) powder, binder, conductive agent, and others. On the other hand, Japanese Patent No. 5587052 (Patent Literature 2) proposes a technique of increasing the capacity of the positive electrode by using a sintered plate of lithium complex oxide as a positive electrode active material that is bonded to a positive electrode current collector. Japanese Patent No. 6943970 (Patent Literature 3) proposes a heat-resistant lithium secondary battery that does not swell even at a high temperature of 150° C., by using, in addition to the sintered plate of lithium complex oxide, a negative electrode that contains carbon and styrene butadiene rubber (SBR), and an electrolytic solution that contains lithium tetrafluoroborate (LiBF₄) in a non-aqueous solvent composed of γ-butyrolactone (GBL), or of γ-butyrolactone (GBL) and ethylene carbonate (EC).

### CITATION LIST

### Patent Literature

Patent Literature 1: Japanese Patent Application Laid-Open No. 2017-79192

Patent Literature 2: Japanese Patent No. 5587052

Patent Literature 3: Japanese Patent No. 6943970

### SUMMARY OF INVENTION

### Technical Problem

Recently, lithium secondary batteries are sometimes used in high-temperature and reduced-pressure environments. Even in such cases, it is desired that the batteries maintain favorable characteristics, such as a discharge capacity that does not decrease significantly compared to that in a normal temperature and normal pressure environment.

Therefore, one of the objects is to provide a lithium secondary battery that can maintain favorable characteristics even in high-temperature and reduced-pressure environments.

### Solution to Problem

A lithium secondary battery according to the present disclosure is a pouch-type lithium secondary battery. The lithium secondary battery includes: a positive electrode layer composed of a sintered body of lithium complex oxide; a negative electrode layer; a separator interposed between the positive electrode layer and the negative electrode layer; an electrolytic solution containing an electrolyte and a solvent and impregnated into the positive electrode layer, the negative electrode layer, and the separator; and an exterior body having a closed space in which the positive electrode layer, the negative electrode layer, the separator, and the electrolytic solution are accommodated. In a thickness direction of the positive electrode layer, a ratio of a thickness of the exterior body at a temperature of 80° C. and a pressure of 100 Pa to a thickness of the exterior body at a temperature of 25° C. and a pressure of 101325 Pa is 1.05 or more and 2.63 or less.

### Advantageous Effects of Invention

The lithium secondary battery described above can maintain favorable characteristics even in high-temperature and reduced-pressure environments.

### BRIEF DESCRIPTION OF DRAWINGS

FIG. 1 is a schematic plan view showing the structure of a lithium secondary battery according to the present disclosure.

FIG. 2 is a schematic cross-sectional view showing the structure of the lithium secondary battery according to the present disclosure.

FIG. 3 is a diagram schematically showing a cross section of the lithium secondary battery according to the present disclosure.

FIG. 4 is a schematic diagram illustrating the assembly process of a lithium secondary battery.

FIG. 5 is a schematic cross-sectional view showing a portion of a measuring device used to measure the thickness of an exterior body.

### DESCRIPTION OF EMBODIMENTS

### Outline of Embodiments

First, aspects of the present disclosure will be listed and described. The lithium secondary battery according to the present disclosure is a pouch-type lithium secondary battery. The lithium secondary battery includes: a positive electrode layer composed of a sintered body of lithium complex oxide; a negative electrode layer; a separator interposed between the positive electrode layer and the negative electrode layer; an electrolytic solution containing an electrolyte and a solvent and impregnated into the positive electrode layer, the negative electrode layer, and the separator; and an exterior body including a closed space in which the positive electrode layer, the negative electrode layer, the separator, and the electrolytic solution are accommodated. In a thickness direction of the positive electrode layer, a ratio of a thickness of the exterior body at a temperature of 80° C. and a pressure of 100 Pa to a thickness of the exterior body at a temperature of 25° C. and a pressure of 101325 Pa is 1.05 or more and 2.63 or less.

According to the lithium secondary battery of such a configuration, the change in thickness is relatively small even in high-temperature and reduced-pressure environments. This can suppress the increase of the distance between the positive electrode layer and the negative electrode layer stacked in the thickness direction. Therefore, favorable characteristics can be maintained even in high-temperature and reduced-pressure environments.

In the lithium secondary battery of the above aspect, the positive electrode layer may be a plate-shaped electrode. The negative electrode layer may be a plate-shaped electrode. With this, in both the positive electrode layer and the negative electrode layer, the changes in dimension in the thickness direction due to swelling and the like can be made relatively small even in high-temperature and reduced-pressure environments. Therefore, more favorable characteristics can be maintained even in high-temperature and reduced-pressure environments.

In the lithium secondary battery of any of the above aspects, the solvent may be a mixed liquid solvent containing a first substance that is an ester and has a carbonate, and a second substance that is an ester different from the first substance and has a carbonate or a lactone. A volume ratio of the first substance to the second substance may be within a range of 1:10 or more and 10:1 or less. An electrolytic solution using such a solvent has a relatively low vapor pressure, and it is unlikely that reaction products will be generated due to side reactions. Consequently, the exterior body is less likely to swell, which further suppresses the increase of the distance between the positive electrode layer and the negative electrode layer. Therefore, more favorable characteristics can be maintained even in high-temperature and reduced-pressure environments. If the volume ratio falls outside the above range, it is difficult to achieve the effect of lowering the vapor pressure enough to suppress the swelling of the exterior body in high-temperature and reduced-pressure environments. Alternatively, the battery characteristics may deteriorate because the viscosity of the electrolytic solution may increase, or because a solid electrolyte interphase (SEI) film is less likely to form on the electrode surface.

In the lithium secondary battery of any of the above aspects, the electrolyte may be contained at a concentration of 2.0 mol/L or more and 8.0 mol/L or less. As such, when the electrolyte concentration is relatively high, the vapor pressure is relatively low, and it is unlikely that reaction products will be generated due to side reactions. Consequently, the exterior body is less likely to swell, which further suppresses the increase of the distance between the positive electrode layer and the negative electrode layer. Therefore, favorable characteristics can be maintained even in high-temperature and reduced-pressure environments.

The lithium secondary battery of any of the above aspects may further include an adhesive composed of a mixed resin of an acid-modified polyolefin resin and an epoxy resin, the adhesive bonding at least one of the positive electrode layer and the negative electrode layer to the exterior body within the closed space. Using such an adhesive to bond the positive electrode layer or the negative electrode layer to the exterior body can suppress the occurrence of wrinkling in the exterior body when the lithium secondary battery of the present disclosure is utilized as a power supply source in a sheet-shaped device or in a flexible device.

The lithium secondary battery of any of the above aspects may further include an adhesive composed of a mixed resin of an acid-modified polyolefin resin and an epoxy resin, the adhesive bonding at least one of the positive electrode layer and the negative electrode layer to the exterior body within the closed space. The positive electrode layer may be a plate-shaped electrode. The negative electrode layer may be a plate-shaped electrode or a coated electrode. The solvent may be a mixed solvent containing sulfolane and γ-butyrolactone. A volume ratio of the sulfolane to the γ-butyrolactone may be 7:3 or more and 4:1 or less. The electrolyte may be contained at a concentration of 1.5 mol/L or more and 5.0 mol/L or less. The lithium secondary battery with such a configuration can reliably maintain more favorable characteristics even in high-temperature and reduced-pressure environments.

### Specific Embodiment

A specific embodiment of the lithium secondary battery of the present disclosure will be described below with reference to the drawings. In the drawings referenced below, the same or corresponding portions are denoted by the same reference numerals and the description thereof will not be repeated.

### Embodiment

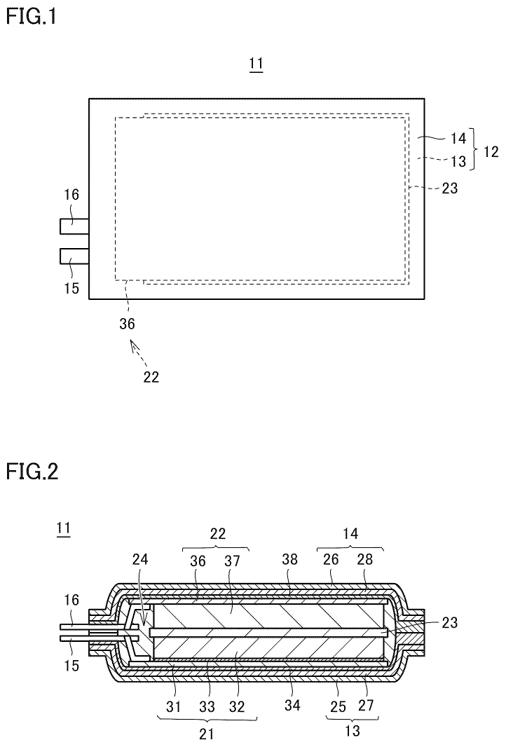

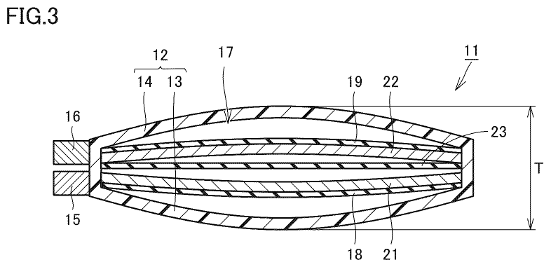

A lithium secondary battery according to the present disclosure will be described. FIG. 1 is a schematic plan view showing the structure of a lithium secondary battery (hereinafter, sometimes simply referred to as “battery”) according to the present disclosure. FIG. 2 is a schematic cross-sectional view showing the structure of the lithium secondary battery according to the present disclosure. FIG. 3 is a diagram schematically showing a cross section of the lithium secondary battery according to the present disclosure. It should be noted that in FIGS. 1, 2, and 3, some configurations are enlarged, emphasized, or omitted from the standpoint of facilitating understanding. The configurations illustrated in FIGS. 1, 2, and 3 do not necessarily reflect the actual dimensional relationships.

Referring to FIGS. 1, 2, and 3, the battery 11 as the lithium secondary battery of the present disclosure is of a pouch type. The battery 11 of the present disclosure is used effectively in high-temperature and reduced-pressure environments; for example, it is used as a power source for supplying power to a temperature sensor that detects the temperature of a chamber in a semiconductor manufacturing apparatus. A high-temperature environment refers to, for example, a temperature of at least 80° C., and a reduced-pressure environment refers to, for example, a pressure of 100 Pa (pascals) or less.

The battery 11 includes a pair of exterior films 13 and 14, constituting an exterior body 12, a positive electrode tab terminal 15, and a negative electrode tab terminal 16. The exterior films 13 and 14 have the same rectangular shape in plan view (i.e., in the state shown in FIG. 1). The peripheral edges on the four sides of the exterior films 13 and 14 are bonded together, except for the portions facing each other across the positive electrode tab terminal 15 and the negative electrode tab terminal 16. The specific manner of bonding is not particularly limited, and the bonding may be performed by, for example, adhesion, fusion, or the like.

The battery 11 is a small and thin battery. Although the dimensions of the battery 11 (external dimensions of the exterior body 12) are not particularly limited, the battery may have, for example, a longitudinal length of 10 mm (millimeters) to 46 mm (10 mm or more and 46 mm or less), and a lateral length of 10 mm to 46 mm. The thickness of the battery 11 (external thickness of the exterior body 12) may be, for example, 0.3 mm to 0.45 mm, and preferably 0.4 mm (400 μm (micrometers)) to 0.45 mm. The battery 11 as a whole is a sheet-shaped article, or a flexible plate-shaped article.

The battery 11 has a sealed space 17 formed between inner surfaces of the exterior films 13 and 14 facing each other. The battery body is accommodated in the sealed space 17. The battery 11 includes a positive electrode 21, a negative electrode 22, a separator 23, and an electrolytic solution 24. In the battery 11, the positive electrode 21, the negative electrode 22, the separator 23, and the electrolytic solution 24 are sometimes collectively referred to as the battery body. The positive electrode 21, the negative electrode 22, and the separator 23 are superposed in a predetermined superposition direction. In the example shown in FIG. 2, the positive electrode 21, the separator 23, and the negative electrode 22 are stacked in the up-down direction in FIG. 2. That is, the positive electrode 21 and the negative electrode 22 face each other through the separator 23. In the following description, the upper side and the lower side in FIG. 2 will be referred to as “upper side” and “lower side”, respectively, in the battery 11. The up-down direction in FIG. 2 will be referred to as “up-down direction” or “stacking direction”.

The exterior body 12 is a bag body made up of the exterior films 13 and 14 with their peripheral edges bonded together. The exterior films 13 and 14 are each formed of, for example, a laminated sheet that contains a metal foil 25, 26 made of a metal such as aluminum (Al) and an insulating resin layer 27, 28 laminated together. The exterior films 13 and 14 are arranged such that the metal foils 25 and 26 are located on the outer side of the bag body and the resin layers 27 and 28 are located on the inner side of the bag body. The thickness of the exterior body 12 is shown as thickness T in FIG. 3.

The exterior body 12 covers the entirety of the battery body. The exterior body 12 is a bag body, which houses the positive electrode 21, the negative electrode 22, the separator 23, and the electrolytic solution 24 therein. The electrolytic solution 24 is present continuously around the positive electrode 21, the separator 23, and the negative electrode 22. In other words, the electrolytic solution 24 exists between the positive electrode 21 and the negative electrode 22. The electrolytic solution 24 is impregnated into the positive electrode 21, the separator 23, and the negative electrode 22. The positive electrode tab terminal 15 and the negative electrode tab terminal 16 extend to the outside of the exterior body 12. Inside the exterior body 12, the positive electrode tab terminal 15 is connected to a positive electrode current collector 31. With this configuration, the positive electrode tab terminal 15 is electrically connected to the positive electrode 21. The negative electrode tab terminal 16 is connected to a negative electrode current collector 36. With this configuration, the negative electrode tab terminal 16 is electrically connected to the negative electrode 22.

The positive electrode tab terminal 15 and the negative electrode tab terminal 16 each have a strip shape. The positive electrode tab terminal 15 includes a body portion made of a conductive material, and a protective layer made of a resin arranged to cover the surface of the body portion. As with the positive electrode tab terminal 15, the negative electrode tab terminal 16 includes a body portion made of a conductive material, and a protective layer made of a resin arranged to cover the surface of the body portion. For the conductive material constituting the body portions, aluminum (Al), nickel (Ni), or other metal can be adopted.

The separator 23 is arranged on an upper surface of the positive electrode 21 in the stacking direction. The negative electrode 22 is arranged on an upper surface of the separator 23. That is, the negative electrode 22 is arranged in contact with the upper surface side of the separator 23. The positive electrode 21 is arranged in contact with the lower surface side of the separator 23. The positive electrode 21, the negative electrode 22, and the separator 23 each have a rectangular shape, for example, in plan view. The positive electrode 21 and the negative electrode 22 have substantially the same shape and same dimensions with each other in plan view. For the purpose of preventing internal short circuiting, the separator 23 may have larger dimensions than the positive electrode 21 and the negative electrode 22. The positive electrode 21 and the negative electrode 22 face each other almost entirely, except for any misalignment that occurs during the production process or during use.

The dimensions and shape of the positive electrode 21 in plan view (i.e., the dimensions and shape of the main surface of the positive electrode 21) may be a rectangle with side lengths of 9.75 mm to 28.5 mm, for example. Preferably, it may be a rectangle with side lengths of 18.15 mm to 25.5 mm. The area of the positive electrode 21 in plan view (i.e., the area of the main surface of the positive electrode 21) may be, for example, 95 mm² to 812 mm², and preferably 441 mm² to 812 mm².

The negative electrode 22 may have the dimensions, shape, and area similar to those of the positive electrode 21. Alternatively, the negative electrode 22 may have dimensions slightly larger (by about 4% to about 7%) than the positive electrode 21. That is, the dimensions and shape of the negative electrode 22 in plan view (i.e., the dimensions and shape of the main surface of the negative electrode 22) may be a rectangle with side lengths of 10.45 mm to 29.2 mm, for example. Preferably, it may be a rectangle with side lengths of 18.8 mm to 26.15 mm. The area of the negative electrode 22 in plan view (i.e., the area of the main surface of the negative electrode 22) may be, for example, 109 mm² to 852 mm², and preferably 470 mm² to 852 mm².

### Positive Electrode Structure 1

The positive electrode 21 includes the positive electrode current collector 31, a positive electrode active material plate 32, and a conductive bonding layer 33. The positive electrode current collector 31 is a sheet-shaped member having conductivity. The positive electrode 21 is a so-called plate-shaped electrode. The positive electrode current collector 31 has its lower surface bonded to the resin layer 27 of the exterior body 12 via a positive electrode bonding layer 34. The positive electrode bonding layer 34 is formed of, for example, a mixed resin of an acid-modified polyolefin resin and an epoxy resin. The positive electrode bonding layer 34 may be formed of another material. The positive electrode bonding layer 34 has a thickness of, for example, 0.5 μm to 10 μm.

The positive electrode current collector 31 includes, for example, a metal foil formed of a metal such as aluminum, and a conductive carbon layer stacked on an upper surface of the metal foil. In other words, a main surface of the positive electrode current collector 31, facing the positive electrode active material plate 32, is covered with the conductive carbon layer. The metal foil may be formed of various metals other than aluminum (for example, copper, nickel, silver, gold, chromium, iron, tin, lead, tungsten, molybdenum, titanium, zing, or an alloy containing any of them). The positive electrode current collector 31 may not necessarily include the conductive carbon layer.

The positive electrode active material plate 32 is a thin plate-shaped ceramic sintered body containing lithium complex oxide. Preferably, the positive electrode active material plate 32 is composed substantially solely of the lithium complex oxide. The separator 23 is stacked on an upper surface of the positive electrode active material plate 32. The positive electrode active material plate 32 may be sputtered with gold (Au) or the like as a current collection aid.

The positive electrode active material plate 32 has a structure in which a plurality of (i.e., a large number of) primary particles are bound together. The primary particles are composed of a lithium complex oxide having a layered rock-salt structure. The lithium complex oxide is a complex oxide of lithium and a transition metal element M (general formula: LiₚMO₂ (where 0.05≤p≤1.10), in which the metal element is partially substituted with another metal element, a substitution metal element. The transition metal element M includes at least one selected from cobalt (Co), nickel (Ni), and manganese (Mn), for example. The transition metal element M is a main metal other than lithium contained in the above-described lithium complex oxide, and is hereinafter referred to as “main transition metal element”.

Examples of the complex oxide of lithium and transition metal element M include lithium cobaltate (LiₚCoO₂ (where 1≤p≤1.1)), lithium nickelate (LiNiO₂), lithium manganate (Li₂MnO₃), lithium nickel manganate (Liₚ(Ni_{0.5},Mn_{0.5})O₂), a solid solution expressed by general formula: Liₚ(Coₓ,Ni_{y},Mn_{z})O₂ (where 0.97≤p≤1.07, x+y+z=1), a solid solution expressed by Liₚ(Coₓ,Ni_{y},Al_{z})O₂ (where 0.97≤p≤1.07, x+y+z=1, 0<x≤0.25, 0.6≤y≤0.9, and 0<z≤0.1), and a solid solution of LizMnO3 and LiMO2 (where M represents Co, Ni, or other transition metal). The lithium complex oxide is particularly preferably lithium cobaltate LiₚCoO₂ (where 1≤p≤1.1), which is, for example, LiCoO₂.

The transition metal element M may be, for example, at least one element from magnesium (Mg), aluminum (Al), silicon (Si), calcium (Ca), titanium (Ti), vanadium (V), chromium (Cr), iron (Fe), copper (Cu), zinc (Zn), gallium (Ga), germanium (Ge), strontium (Sr), yttrium (Y), zirconia (Zr), niobium (Nb), molybdenum (Mo), silver (Ag), tin (Sn), antimony (Sb), tellurium (Te), barium (Ba), and bismuth (Bi). Preferably, it is titanium (Ti) or niobium (Nb).

The layered rock-salt structure is a crystal structure in which layers of lithium and layers of transition metals other than lithium are stacked alternately, with oxygen layers interposed therebetween. That is, the layered rock-salt structure is a crystal structure in which layers of metal ions other than lithium and layers of lithium alone are stacked alternately with the intermediary of oxide ions. Typically, it is an a-NaFeO2 type structure, i.e., a structure in which the transition metals and lithium are arranged regularly in the axial direction of a cubic rock-salt type structure.

The conductive bonding layer 33 includes conductive powder and a binder. The conductive powder is powder of, for example, acetylene black, natural flake graphite, carbon nanotube, carbon nanofiber, carbon nanotube derivative, or carbon nanofiber derivative. The binder contains, for example, a polyimide amide resin. The binder may contain one type or two or more types of polyimide amide resin. The binder may contain a resin other than polyimide amide resin. The conductive bonding layer 33 may be formed by applying a liquid or paste adhesive, containing the above-described conductive powder and binder as well as a solvent, to the positive electrode current collector 31 or the positive electrode active material plate 32 and allowing it to solidify by evaporation of the solvent between the positive electrode current collector 31 and the positive electrode active material plate 32.

The positive electrode current collector 31 has a thickness of, for example, 9 μm to 50 μm, preferably 9 μm to 20 μm, and more preferably 9 μm to 15 μm. The positive electrode active material plate 32 has a thickness of, for example, 15 μm to 200 μm, preferably 30 μm to 150 μm, and more preferably 50 μm to 100 μm. The conductive bonding layer 33 has a thickness of, for example, 3 μm to 28 μm, and preferably 5 μm to 25 μm.

### Positive Electrode Structure 2

In the lithium secondary battery according to the present disclosure, the positive electrode 21 is not limited to the plate-shaped electrode. That is, the positive electrode 21 may be a coated electrode. In this case, the positive electrode 21 includes the above-described positive electrode current collector 31, and a positive electrode active material layer coated on the positive electrode current collector 31. The positive electrode active material layer includes the above-described lithium complex oxide as the positive electrode active material, and a binder having a resin as its principal component. The lithium complex oxide is, as explained above, a complex oxide of lithium and a main transition metal element (e.g., Co, Ni, Mn), in which the metal element is partially substituted with a substitution metal element (e.g., Nb, Ti). The binder is, for example, styrene butadiene rubber (SBR), polyvinylidene fluoride (PVDF), or a mixture thereof.

An example of a method of producing the positive electrode 21 in the case where the positive electrode 21 is a coated electrode will now be described. In the following description, the case where the main transition metal element and the substitution metal element are Co and Nb, respectively, will be described. First, as in the case where the positive electrode 21 includes the positive electrode active material plate 32, mixed powder of an oxide of lithium and an oxide of the main transition metal element (i.e., Co) is prepared. The mixed powder is held at 900° C. for 10 hours.

Subsequently, as in the case where the positive electrode 21 includes the positive electrode active material plate 32, Nb₂O₅ powder (produced by MITSUI MINING & SMELTING CO., LTD.) is added to the above mixed powder, and the mixture is pulverized and disintegrated in a pot mill to achieve a particle size distribution with a volume-based D50 particle size of 0.8 μm, to thereby obtain raw material powder. The percentage of Nb₂O₅ powder added to the raw material powder is 0.03 mass %, and the Nb content in the raw material powder is 0.021 mass %. The volume-based D50 particle size of the raw material powder may be changed as appropriate within a range of 0.2 μm to 10 μm, for example. The Nb content in the raw material powder may also be changed as appropriate within a range of 0.1 mass % to 2.0 mass %, for example.

Next, 91 mass % of the above-described raw material powder, 5 mass % of acetylene black, 4 mass % of polyvinylidene fluoride (PVDF), and a solution of N-methylpyrrolidone (NMP) are mixed together to prepare a slurry. The slurry is then applied onto the positive electrode current collector 31 (e.g., 10 μm-thick aluminum foil) and dried. Thereafter, the dried coating layer is pressed, whereby the positive electrode 21 as the coated electrode is fabricated.

The resultant positive electrode 21 is combined with the other members, as in Battery Production Example 1, to obtain a lithium secondary battery 11.

### Negative Electrode Structure 1

The negative electrode 22 includes the negative electrode current collector 36 and a negative electrode active material layer 37. The negative electrode current collector 36 is a sheet-shaped member having conductivity. The negative electrode current collector 36 has its upper surface bonded to the resin layer 28 of the exterior film 14 via a negative electrode bonding layer 38. The negative electrode active material layer 37 is coated on the lower surface of the negative electrode current collector 36. That is, the negative electrode 22 is a so-called coated electrode. The negative electrode active material layer 37 faces the separator 23 in the up-down direction.

The negative electrode bonding layer 38 is formed of, for example, a mixed resin of an acid-modified polyolefin resin and an epoxy resin. The negative electrode bonding layer 38 may be formed of various other materials.

The negative electrode current collector 36 is, for example, a metal foil formed of a metal such as copper. The metal foil may be formed of various metals other than copper (e.g., copper, stainless steel, nickel, aluminum, silver, gold, chromium, iron, tin, lead, tungsten, molybdenum, titanium, zinc, or an alloy containing any of them).

The negative electrode active material layer 37 includes a binder with a resin as its main component, and a carbonaceous material as the negative electrode active material. Examples of the carbonaceous material include natural graphite, artificial graphite, pyrolytic carbon, coke, fired resin, mesophase spherules, and mesophase pitch. In the negative electrode 22, a lithium-occluding material may be utilized as the negative electrode active material in place of the carbonaceous material. Examples of the lithium-occluding material include silicon, aluminum, tin, iron, iridium, and alloys, oxides, and fluorides containing any of them. The binder is, for example, styrene butadiene rubber (SBR), polyvinylidene fluoride (PVDF), or a mixture thereof.

The negative electrode current collector 36 has a thickness of, for example, 5 μm to 25 μm, preferably 8 μm to 20 μm, and more preferably 8 μm to 15 μm. The negative electrode active material layer 37 has a thickness of, for example, 20 μm to 300 μm, preferably 30 μm to 250 μm, and more preferably 30 μm to 150 μm. Increasing the thickness of the negative electrode active material layer 37 can increase the active material capacity per unit area, thereby increasing the energy density of the battery 11. Reducing the thickness of the negative electrode active material layer 37 can suppress the deterioration of the battery characteristics (particularly, increase of the resistance value) due to repeated charging and discharging.

### Negative Electrode Structure 2

In the lithium secondary battery according to the present disclosure, the negative electrode is not limited to the coated electrode. The negative electrode may be formed by using a sintered plate of lithium titanate (Li₄Ti₅O₁₂) (hereinafter, sometimes referred to as LTO) as the configuration corresponding to the negative electrode active material layer 37. The LTO sintered plate has a structure in which a plurality of (i.e., a large number of) primary particles are bound together. These primary particles are composed of LTO.

Although LTO is known to typically have a spinel structure, it may take a different structure during charging and discharging. For example, the reaction of LTO proceeds in a two-phase coexistence of Li₄Ti₅O₁₂ (spinel structure) and Li₇Ti₅O₁₂ (rock-salt structure) during charging and discharging. Therefore, the structure of LTO is not limited to the spinel structure.

The primary particle diameter, which is the average particle diameter of the primary particles constituting the LTO sintered plate, may be 1.2 μm or less. It is preferably 0.02 μm to 1.2 μm, and more preferably 0.05 μm to 0.7 μm. The thickness of the LTO sintered plate may be 10 μm to 290 μm. It is preferably 10 μm to 200 μm, more preferably 40 μm to 200 μm, still more preferably 40 μm to 175 μm, and particularly preferably 50 μm to 160 μm. The thicker the LTO sintered plate, the easier it is to achieve a battery of high capacity and high energy density.

The LTO sintered plate includes pores. When the LTO sintered plate has pores, in particular open pores, it is easier for the electrolytic solution to permeate into the LTO sintered plate when the plate is incorporated into a battery as a negative electrode. This results in improved lithium ion conductivity. The LTO sintered plate has a porosity of, for example, 21% to 45%, more preferably 22% to 40%, and further preferably 25% to 35%. The porosity within such a range ensures both lithium ion conductivity and electron conductivity. In the LTO sintered plate, an open pore ratio, which is the ratio of open pores to whole pores, may be 60% or more. The ratio is more preferably 65% or more, further preferably 70% or more, and particularly preferably 80% or more. The open pore ratio may be 100%. As the number of the open pores increases, it becomes easier for the electrolytic solution to sufficiently permeate into the sintered plate, thus improving lithium ion conductivity.

### Separator

The separator 23 is a sheet-shaped or thin plate-shaped insulating member. The separator 23 is, for example, a single layer separator formed of a resin. For the resin, for example, polyimide, polyester (e.g., polyethylene terephthalate (PET)), or cellulose can be adopted. The separator 23 has a thickness of, for example, 15 um or more, preferably 18 um or more, and more preferably 20 um or more. The thickness of the separator 23 is, for example, 31 um or less, preferably 28 um or less, and more preferably 26 um or less. By making the separator thicker, even if lithium dendrites (dendritic crystals of lithium) precipitate, a short circuit between the positive electrode and the negative electrode due to the lithium dendrites can be prevented. Alternatively, making the separator thinner facilitates permeation of the electrolytic solution and lithium ions, thereby reducing the internal resistance of the battery 11.

The structure of the separator 23 may be changed to any known structure other than the above. For example, two layers or three or more layers of ceramic and resin may be stacked. Alternatively, it may be a microporous membrane made solely of ceramic. The ceramic is, for example, at least one selected from MgO, Al₂O₃, ZrO, SiC, Si₃N₄, AlN, and cordierite, and preferably at least one selected from MgO, Al₂O₃, and ZrO₂.

### Electrolytic Solution

The electrolytic solution 24 is a liquid that contains an electrolyte and an additive added to a solvent. The electrolyte is, for example, lithium hexafluorophosphate (LiPF₆). The electrolyte can be changed and may be lithium tetrafluoroborate (LiBF₄), for example. The concentration of the electrolytic solution 24 may be, for example, 1.0 mol/L to 8.0 mol/L. It is preferably 1.5 mol/L or more, more preferably 2.0 mol/L or more, further preferably 4.0 mol/L or more, and further preferably 5.0 mol/L or more. The preferable numerical range of the concentration of the electrolytic solution 24 is, for example, 1.5 mol/L to 8.0 mol/L, more preferably 2.0 mol/L to 8.0 mol/L, and further preferably 4.0 mol/L to 5.0 mol/L.

The solvent of the electrolytic solution 24 is a non-aqueous solvent of, for example, ethylene carbonate (EC), propylene carbonate (PC), dimethyl carbonate (DMC), diethyl carbonate (DEC), ethyl methyl carbonate (EMC), γ-butyrolactone (GBL), methyl butyrate (MB), propyl acetate (PA), or the like. The solvent may be one containing EC and EMC, for example.

### Thickness of Lithium Secondary Battery in High-Temperature and Reduced-Pressure Environments

In the lithium secondary battery according to the present disclosure, the ratio of the thickness of the exterior body 12 in an environment of high temperature and reduced pressure to the thickness of the exterior body 12 in an environment of normal temperature and normal pressure is 1.05 or more and 2.63 or less. Specifically, the ratio of the thickness of the exterior body 12 at a temperature of 80° C. and a pressure of 100 Pa to the thickness of the exterior body 12 at a temperature of 25° C. and a pressure of 101325 Pa is 1.05 or more and 2.63 or less. More preferably, the ratio of the thickness of the exterior body 12 at the temperature of 80° C. and the pressure of 100 Pa to the thickness of the exterior body 12 at the temperature of 25° C. and the pressure of 101325 Pa is 1.05 or more and 1.50 or less.

### EXAMPLES

The lithium secondary battery of the present disclosure will be described in more detail below by way of Examples and Comparative Examples.

### Example 1

A lithium secondary battery was fabricated in accordance with the methods described in (1) to (3) below. The resultant lithium secondary battery was evaluated using the methods described in (4).

In the following Examples and Comparative Examples, during fabrication of green sheets, the viscosity of the slurry was measured using an LVT viscometer produced by AMETEK Brookfield, Inc. Additionally, the slurry was formed on a PET film by doctor blading.

### (1) Fabrication of Positive Electrode

### (1a) Fabrication of LiCoO₂ (LCO) Green Sheet

Co₃O₄ powder (produced by Seido Chemical Industry Co., Ltd.) and Li2CO₃ powder (produced by The Honjo Chemical Corporation), weighed to a Li/Co molar ratio of 1.01, were mixed, and then held at 780° C. for five hours. The resultant powder was pulverized in a pot mill to have a volume-based standard Dso of 0.4 μm. Then, 100 parts by weight of the resultant LCO powder, 100 parts by weight of a dispersion medium (toluene: isopropanol=1:1), 10 parts by weight of a binder (polyvinyl butyral: product number BM-2, produced by SEKISUI CHEMICAL CO., LTD.), 4 parts by weight of a plasticizer (DOP: Di(2-ethylhexyl)phthalate, produced by Kurogane Kasei Co., Ltd.), and 2 parts by weight of a dispersant (product name: RHEODOL SP-O_{30,} produced by Kao Corporation) were mixed. The resultant mixture was stirred and defoamed under reduced pressure, and also adjusted to a viscosity of 4000 cP to prepare a LiCoO₂ slurry. The slurry prepared was formed into a sheet shape on a PET film, to thereby form a LiCoO₂ green sheet. The LiCoO₂ green sheet had a thickness of 98 μm after drying.

### (1b) Fabrication of LiCoO₂ Sintered Plate

The LiCoO₂ green sheet, stripped off from the PET film, was cut into a 50-mm square using a cutter, and placed in the center of a setter made of magnesia (with dimensions of 90-mm square and height of 1 mm) as a bottom setter. On the LiCoO₂ sheet, a setter made of porous magnesia was placed as a top setter. The LiCoO₂ sheet, in the state of being sandwiched between the setters, was placed in an alumina sheath of 120-mm square (produced by NIKKATO CORPORATION). At this time, the alumina sheath was not tightly sealed, and was covered with a lid with a gap of 0.5 mm. The resultant stack was heated to 600° C. at a heating rate of 200° C./h and debindered for three hours, and then heated to 920° C. at 200° C./h and then held for four hours for firing. After the firing, the fired body was cooled to a room temperature and then removed from the alumina sheath. According to the above-described procedure, a LiCoO₂ sintered plate with a thickness of 90 μm was obtained as a positive electrode. The resultant positive electrode was cut into a rectangular shape of 9.75 mm×18.15 mm using a laser machine, to obtain a chip-shaped positive electrode.

### (2) Fabrication of Negative Electrode

### (2a) Fabrication of Li₄Ti₅O₁₂ (LTO) Green Sheet

First, 100 parts by weight of LTO powder (volume-based Dso particle size: 0.06 um, produced by Sigma-Aldrich Japan K.K.), 100 parts by weight of a dispersion medium (toluene: isopropanol=1:1), 20 parts by weight of a binder (polyvinyl butyral: product number BM-2, produced by SEKISUI CHEMICAL CO., LTD.), 4 parts by weight of a plasticizer (DOP: Di(2-ethylhexyl)phthalate, produced by Kurogane Kasei Co., Ltd.), and 2 parts by weight of a dispersant (product name: RHEODOL SP-030, produced by Kao Corporation) were mixed. The resultant negative electrode raw material mixture was stirred and defoamed under reduced pressure, and also adjusted to a viscosity of 4000 cP to prepare an LTO slurry. The slurry prepared was formed into a sheet shape on a PET film, to thereby form an LTO green sheet. The thickness of the LTO green sheet after drying was adjusted such that the thickness would be 110 μm after firing.

### (2b) Firing of LTO Green Sheet

The resultant green sheet was cut into a 25-mm square with a cutting knife and placed on an embossed setter made of zirconia. The green sheet on the setter was placed in an alumina sheath and held at 500° C. for five hours, then heated at a heating rate of 200° C./h, and held at 800° C. for five hours for firing. On the surface of the resultant LTO sintered plate that had been in contact with the setter, an Au film (thickness: 100 nm) was formed by sputtering to serve as a current collecting layer, and then the plate was laser machined into a rectangular shape of 9.12 mm×17.52 mm.

### (3) Assembly of Lithium Secondary Battery

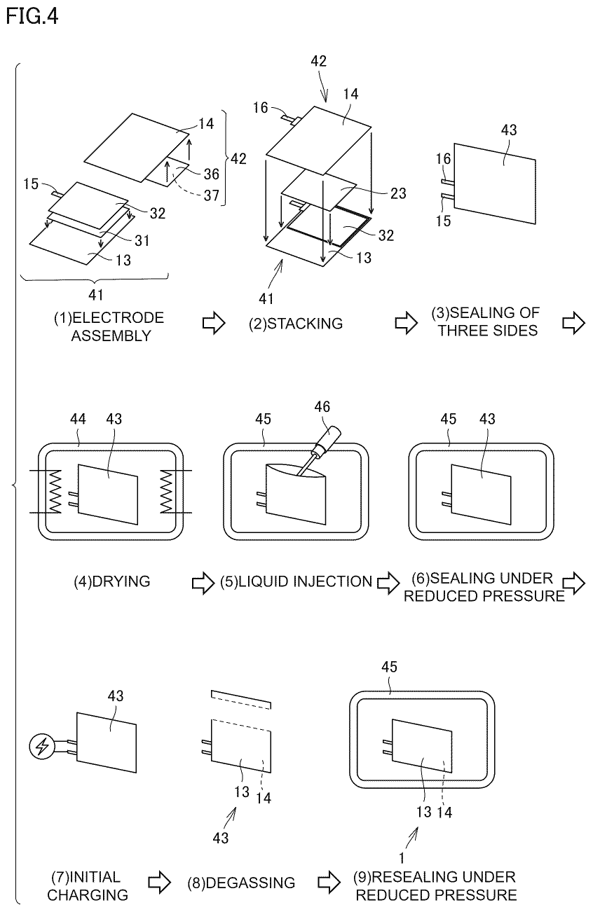

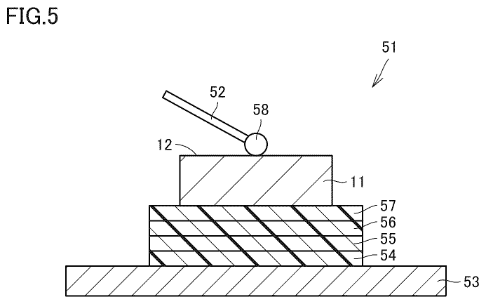

The lithium secondary battery 11, which is a form of lithium secondary battery schematically shown in FIG. 1, was fabricated using the following procedure. The outline of the production process is shown schematically in FIG. 4. FIG. 4 is a schematic diagram illustrating the assembly process of a lithium secondary battery.

As the exterior films 13 and 14, two sheets of aluminum laminated film (produced by Showa Denko Packaging Co., Ltd., thickness: 61 μm, three layer structure of polypropylene film/aluminum foil/nylon film) were prepared. As illustrated in (1) of FIG. 4, one positive electrode active material plate 32 was stacked on one exterior film 13 via a positive electrode current collector 31 (9 μm-thick aluminum foil) to form a positive electrode assembly 41. At this time, the positive electrode current collector 31 was not secured to the exterior film 13 with an adhesive. It should be noted that the positive electrode current collector 31 has a positive electrode tab terminal 15 secured thereto by welding in such a way that it protrudes from the positive electrode current collector 31. On the other hand, a negative electrode active material layer 37 was stacked on the other exterior film 14 via a negative electrode current collector 36 (9 μm-thick aluminum foil) to form a negative electrode assembly 42. At this time, the negative electrode current collector 36 was not secured to the exterior film 14 with an adhesive. The negative electrode current collector 36 has a negative electrode tab terminal 16 secured thereto by welding in such a way that it protrudes from the negative electrode current collector 36.

As the separator 23, a cellulose membrane (produced by Nippon Kodoshi Corporation, thickness: 20 μm, density: 0.47 g/cm³) was prepared. As illustrated in (2) of FIG. 4, the positive electrode assembly 41, the separator 23, and the negative electrode assembly 42 were stacked in sequence such that the positive electrode active material plate 32 and the negative electrode active material layer 37 faced the separator 23. Thus, a stacked body 43 was obtained, which had both surfaces covered with the exterior films 13 and 14, with the outer peripheral portions of the exterior films 13 and 14 extending beyond the outer edges of the battery elements. The battery elements (positive electrode current collector 31, positive electrode active material plate 32, separator 23, negative electrode active material layer 37, and negative electrode current collector 36), constructed within the stacked body 43, had a thickness of 0.33 mm. They had a size and shape of a quadrangle of 1.3 cm×2.2 cm.

As illustrated in (3) of FIG. 4, three sides of the resultant stacked body 43 were sealed. The sealing was performed, using a patch jig (heat bar) adjusted to have a sealing width of 2.0 mm, by hot-pressing the outer peripheral portion of the stacked body 43 at 200° C. and 1.5 MPa for 15 seconds to thermally fuse the exterior films 13 and 14 (aluminum laminated films) together at the outer peripheral portion.

As illustrated in (4) of FIG. 4, after the sealing of the three sides, the stacked body 43 was placed in a vacuum dryer 44, where moisture was removed and the adhesive was dried.

Subsequently, as illustrated in (5) of FIG. 4, in a glove box 45, a gap was formed between the exterior films 13 and 14 at the remaining unsealed side of the stacked body 43, whose three outer edges had been sealed. An injector 46 was inserted into the gap to inject the electrolytic solution 24.

As illustrated in (6) of FIG. 4, the previously unsealed side was temporarily sealed using a simple sealer under a reduced-pressure atmosphere of absolute pressure of 5 kPa. For the electrolytic solution, a liquid obtained by dissolving LiBF4 to a concentration of 1.5 mol/L in an organic solvent containing ethylene carbonate (EC) and γ-butyrolactone (GBL) mixed at a volume ratio of 1:3 was used.

As illustrated in (7) of FIG. 4, the temporarily sealed stacked body 43 was initially charged, and was aged at 120° C. for one hour.

As illustrated in (8) of FIG. 4, after the completion of the aging, the outer peripheral portion of the side that was sealed last (the end portion not including any battery elements) was cut off for degassing.

Subsequently, as illustrated in (9) of FIG. 4, in the glove box 45, an opened site produced by cutting off the temporarily sealed portion was sealed under a reduced-pressure atmosphere of absolute pressure of 5 kPa. This sealing was also performed by hot-pressing the outer peripheral portion of the stacked body 43 at 200° C. and 1.5 MPa for 15 seconds to thermally fuse the exterior films 13 and 14 together at the outer peripheral portion. The battery 11 in the form of a lithium secondary battery was produced. The battery 11 was removed from the glove box 45, and the excess portions on the outer peripheries of the exterior films 13 and 14 were cut off to shape the battery 11. In the above-described manner, the battery 11 as the lithium secondary battery was obtained in which the four outer edges of the battery elements were sealed with the pair of exterior films 13 and 14 and the electrolytic solution 24 was injected. The resultant battery 11 had a rectangular shape with a size of 27 mm×17 mm and a thickness of 0.40 mm (400 μm).

### (4) Evaluation

### Measurement of Exterior Body Thickness

Here, a method for measuring the thickness of the exterior body 12 will be described in brief. FIG. 5 is a schematic cross-sectional view showing a portion of a measuring device 51 used to measure the thickness of the exterior body 12. Referring to FIG. 5, first, a bell jar type vacuum oven (produced by SIBATA SCIENTIFIC TECHNOLOGY LTD., model BV-001) is prepared. Then, a dial gauge (produced by Mitsutoyo Corporation) 52 is secured on the bell jar type vacuum oven using double-sided tape and polyimide tape. In the condition of room temperature and normal pressure (normal temperature and normal pressure), polyimide sheets 54, 55, 56, 57 are placed on a plate 53, and the battery 11 (exterior body 12) is placed thereon. At this time, it is ensured that a tip end 58 of the dial gauge 52 is positioned at the center of the battery 11. Here, the number of polyimide sheets 54, 55, 56, 57 is adjusted such that the tip end 58 contacts the battery 11, and the value of the dial gauge 52 in the contact state is set to zero. After the dial gauge 52 is adjusted, the battery 11 is removed from the plate 53.

Next, the temperature of the bell jar type vacuum oven is set, and it is waited until the set temperature (80° C.) is stabilized. During this time, the polyimide sheets 54, 55, 56, 57 are also heated.

Next, the battery 11 is placed on the polyimide sheets 54, 55, 56, 57, which have been placed on the plate 53, and is left for two minutes. The number of polyimide sheets 54, 55, 56, 57 is as previously adjusted. At this time, it is ensured that the tip end 58 of the dial gauge 52 is positioned at the center of the battery 11.

Next, the bell jar is placed on top, and vacuuming (depressurizing) is started.

The value on the dial gauge 52 is read when the vacuum gauge reaches 100 Pa. The thickness of the exterior body 12 is determined to be a value obtained by adding (the value of the dial gauge 52) and (the thickness of the exterior body 12 at room temperature and normal pressure). (Thickness of exterior body 12=(value of dial gauge 52)+(thickness of exterior body 12 at room temperature and normal pressure)).

In the case where the needle of the dial gauge 52 swings out of range, hindering measurement, the measurement is repeated by removing one sheet at a time of the polyimide sheets 54, 55, 56, 57 placed under the battery 11, until the measurement is achieved. Each time a polyimide sheet 54, 55, 56, 57 is removed, the thickness of the exterior body 12 is determined to be a value calculated as follows: (value of dial gauge 52)+(thickness of polyimide sheet 54, 55, 56, 57×number of sheets removed)+(thickness of exterior body 12 at room temperature and normal pressure).

If the measurement is not possible even when the number of polyimide sheets 54, 55, 56, 57 is zero (i.e., in the state where all the polyimide sheets 54, 55, 56, 57 have been removed), the thickness is determined to be equal to or greater than the value calculated as follows: (maximum value of dial gauge 52)+(thickness of polyimide sheet 54, 55, 56, 57×number of sheets removed)+(thickness of exterior body 12 at room temperature and normal pressure).

### Method for Charging and Discharging Evaluation

The charging and discharging evaluation was conducted as follows. The lithium secondary battery was charged at a constant current of 0.2 C until the charging voltage value was reached, and then charged at a constant voltage until the current reached 0.02 C. The battery was then discharged at a constant current of 0.5 C until the discharge voltage value was reached, and a discharge capacity WO at normal temperature and normal pressure was measured. In the case of measuring in high-temperature and reduced-pressure environments, the temperature of the bell jar type vacuum oven was set and stabilized. The battery 11 was then placed on the plate, covered with the bell jar, and the pressure was reduced to 100 Pa. The charging and discharging evaluation was conducted in a manner similar to that at normal temperature and normal pressure, and a discharge capacity W1 at reduced pressure was measured. A discharge capacity retention rate (%) was calculated by dividing the discharge capacity W1 by the discharge capacity WO and expressing the result as a percentage.

### Example 2

A lithium secondary battery was obtained as in Example 1, except that an organic solvent containing ethylene carbonate (EC) and γ-butyrolactone (GBL) mixed at a volume ratio of 7:3 was used as the electrolytic solution 24. The evaluations were conducted as in Example 1.

### Example 3

A lithium secondary battery was obtained as in Example 1, except that the positive electrode current collector 31 was secured to the exterior film 13 with an adhesive, and the negative electrode current collector 36 was secured to the exterior film 14 with an adhesive. The adhesive used was composed of a mixed resin of an acid-modified polyolefin resin and an epoxy resin. Specifically, HARDLEN (registered trademark) (produced by Toyobo Co., Ltd.) was used as the adhesive. The evaluations were conducted as in Example 1.

### Example 4)

A lithium secondary battery was obtained as in Example 1, except that a liquid obtained by using an organic solvent containing ethylene carbonate (EC) and γ-butyrolactone (GBL) mixed at a volume ratio of 7:3 and dissolving LiBF₄ therein to a concentration of 4.0 mol/L was used as the electrolytic solution 24. The evaluations were conducted as in Example 1.

### Example 5

The same lithium secondary battery as in Example 4 was used, and the evaluations were conducted similarly, except that the evaluation temperature was set to 120° C.

### Example 6

A lithium secondary battery was obtained as in Example 1, except that a liquid obtained by using an organic solvent containing ethylene carbonate (EC) and propylene carbonate (PC) mixed at a volume ratio of 3:1 and dissolving LiPF₆ therein to a concentration of 1.0 mol/L was used as the electrolytic solution 24. The evaluations were conducted as in Example 1.

### Example 7

A lithium secondary battery was obtained as in Example 1, except that an organic solvent containing sulfolane (SL) and γ-butyrolactone (GBL) mixed at a volume ratio of 7:3 was used as the electrolytic solution 24, and that a plate-shaped electrode was used as the negative electrode 22. The evaluations were conducted as in Example 1.

### Example 8

A lithium secondary battery was obtained as in Example 1, except that a liquid obtained by using an organic solvent containing ethylene carbonate (EC) and γ-butyrolactone (GBL) mixed at a volume ratio of 7:3 and dissolving LiBF₄ therein to a concentration of 4.0 mol/L was used as the electrolytic solution 24, and that a plate-shaped electrode was used as the negative electrode 22. The evaluations were conducted as in Example 1.

### Example 9

A lithium secondary battery was obtained as in Example 1, except that a liquid obtained by using an organic solvent containing ethylene carbonate (EC) and γ-butyrolactone (GBL) mixed at a volume ratio of 7:3 and dissolving LiBF₄ therein to a concentration of 4.0 mol/L was used as the electrolytic solution 24, and that a coated electrode was used as the positive electrode 21. The evaluations were conducted as in Example 1.

### Example 10

A lithium secondary battery was obtained as in Example 1, except that a liquid obtained by using an organic solvent containing sulfolane (SL) and γ-butyrolactone (GBL) mixed at a volume ratio of 4:1 and dissolving LiBF₄ therein to a concentration of 5.0 mol/L was used as the electrolytic solution 24. The evaluations were conducted as in Example 1.

### Comparative Example 1

A lithium secondary battery was obtained as in Example 1, except that a liquid obtained by using an organic solvent containing diethyl carbonate (DEC), propylene carbonate (PC), and ethylene carbonate (EC) mixed at a volume ratio of 5:1:1 and dissolving LiPF₆ therein to a concentration of 1.0 mol/L was used as the electrolytic solution 24, and that a coated electrode was used as the positive electrode 21. The evaluations were conducted as in Example 1.

### Comparative Example 2

A lithium secondary battery was obtained as in Example 1, except that a liquid obtained by using an organic solvent containing ethylene carbonate (EC) and ethyl methyl carbonate (EMC) mixed at a volume ratio of 1:3 and dissolving LiPF₆ therein to a concentration of 1.0 mol/L was used as the electrolytic solution 24, and that a coated electrode was used as the positive electrode 21. The evaluations were conducted as in Example 1.

Table 1 collectively shows the evaluation results for the lithium secondary batteries of Examples 1 to 10 and Comparative Examples 1 and 2.

TABLE 1

| | SOLVENT FOR | SALT-CONCENTRATION | | |
|---|---|---|---|---|
| | ELECTROLYTIC | IN ELECTROLYTIC | POSITIVE | NEGATIVE |
| | SOLUTION | SOLUTION | ELECTRODE | ELECTRODE |
| EXAMPLE 1 | EC:GBL = 1:3 | 1.5M Li [symbol] F [symbol] | PLATE-SHAPED | COATED |
| EXAMPLE 2 | EC:GBL = 7:3 | 1.5M Li [symbol] F [symbol] | PLATE-SHAPED | COATED |
| EXAMPLE 3 | EC:GBL = 1:3 | 1.5M Li [symbol] F [symbol] | PLATE-SHAPED | COATED |
| EXAMPLE 4 | EC:GBL = 7:3 | 4.0M Li [symbol] F [symbol] | PLATE-SHAPED | COATED |
| EXAMPLE 5 | EC:GBL = 7:3 | 4.0M Li [symbol] F [symbol] | PLATE-SHAPED | COATED |
| EXAMPLE 6 | EC:PC = 3:1 | 1.0M Li [symbol] F [symbol] | PLATE-SHAPED | COATED |
| EXAMPLE 7 | SL:GBL = 7:3 | 1.5M Li [symbol] F [symbol] | PLATE-SHAPED | PLATE-SHAPED |
| EXAMPLE 8 | EC:GBL = 7:3 | 4.0M Li [symbol] F [symbol] | PLATE-SHAPED | PLATE-SHAPED |
| EXAMPLE 9 | EC:GBL = 7:3 | 4.0M Li [symbol] F [symbol] | COATED | COATED |
| EXAMPLE 10 | SL:GBL = 4:1 | 5.0M Li [symbol] F [symbol] | PLATE-SHAPED | COATED |
| COMPARATIVE | DEC:PC:EC = 5:1:1 | 1.0M Li [symbol] F [symbol] | COATED | COATED |
| EXAMPLE 1 | | | | |
| COMPARATIVE | EC:EMC = 1:3 | 1.0M Li [symbol] F [symbol] | COATED | COATED |
| EXAMPLE 2 | | | | |

| | PRESENCE/ | | | | DISCHARGE |
|---|---|---|---|---|---|
| | ABSENCE | MEASUREMENT | | | CAPACITY |
| | OF | TEMPERATURE | THICKNESS | THICKNESS | RETENTION |
| | ADHESIVE | (° C.) | (μm) | RATIO | RATE (%) |
| EXAMPLE 1 | ABSENT | 80 | 910 | 2.28 | 75 |
| EXAMPLE 2 | ABSENT | 80 | 850 | 2.13 | 79 |
| EXAMPLE 3 | PRESENT | 80 | 990 | 2.48 | 72 |
| EXAMPLE 4 | ABSENT | 80 | 750 | 1.88 | 81 |
| EXAMPLE 5 | ABSENT | 120 | 850 | 2.13 | 79 |
| EXAMPLE 6 | ABSENT | 80 | 890 | 2.23 | 7 [symbol] |
| EXAMPLE 7 | PRESENT | 80 | 420 | 1.05 | 98 |
| EXAMPLE 8 | PRESENT | 80 | 550 | 1.40 | 92 |
| EXAMPLE 9 | ABSENT | 80 | 1050 | 2.63 | 70 |
| EXAMPLE 10 | ABSENT | 80 | [symbol] | 1.56 | 91 |
| COMPARATIVE | ABSENT | 80 | 1100 OR | 2.75 OR | 5 |
| EXAMPLE 1 | | | GREATER | GREATER | |
| COMPARATIVE | ABSENT | 80 | 1100 OR | 2.75 OR | 3 |
| EXAMPLE 2 | | | GREATER | GREATER | |

[symbol]

indicates data missing or illegible when filed

As shown in Table 1, the lithium secondary batteries with the ratio of the thickness of the exterior body 12 at a temperature of 80° C. and a pressure of 100 Pa to the thickness of the exterior body 12 at a temperature of 25° C. and a pressure of 101325 Pa of 1.05 or more and 2.63 or less have a discharge capacity retention rate of 70% or more and 98% or less even in high-temperature and reduced-pressure environments, specifically in the environment of the temperature of 80° C. and the pressure of 100 Pa. That is, the lithium secondary batteries of Examples 1 to 10 can maintain favorable characteristics even in high-temperature and reduced-pressure environments. It should be noted that Examples 3, 7, and 8 can suppress the occurrence of wrinkling in the exterior body.

On the other hand, the lithium secondary batteries of Comparative Examples 1 and 2, the thickness ratio of which is greater than 2.63, have a discharge capacity retention rate of 5% or less. Such lithium secondary batteries cannot maintain favorable characteristics in high-temperature and reduced-pressure environments.

It should be understood that the embodiment disclosed herein is illustrative and non-restrictive in every respect. The scope of the present invention is defined by the terms of the claims, rather than the description above, and is intended to include any modifications within the scope and meaning equivalent to the terms of the claims.

Reference Signs List

11: lithium secondary battery (battery); 12: exterior body; 13, 14: exterior film;
15: positive electrode tab terminal; 16: negative electrode tab terminal; 17: sealed space;
21: positive electrode; 22: negative electrode; 23: separator; 24: electrolytic solution; 25,
26: metal foil; 27, 28: resin layer; 31: positive electrode current collector; 32: positive
electrode active material plate; 33: conductive bonding layer; 34: positive electrode
bonding layer; 36: negative electrode current collector; 37: negative electrode active
material layer; 38: negative electrode bonding layer; 41: positive electrode assembly; 42:
negative electrode assembly; 43: stacked body; 44: vacuum dryer; 45: glove box; 46:
injector; 51: measuring device; 52: dial gauge; 53: plate; 54, 55, 56, 57: polyimide sheet;
and 58: tip end.

1. A pouch-type lithium secondary battery, comprising:
a positive electrode layer composed of a sintered body of lithium complex oxide;
a negative electrode layer;
a separator interposed between the positive electrode layer and the negative electrode layer;
an electrolytic solution containing an electrolyte and a solvent and impregnated into the positive electrode layer, the negative electrode layer, and the separator; and
an exterior body including a closed space in which the positive electrode layer, the negative electrode layer, the separator, and the electrolytic solution are accommodated;
in a thickness direction of the positive electrode layer, a ratio of a thickness of the exterior body at a temperature of 80° C. and a pressure of 100 Pa to a thickness of the exterior body at a temperature of 25° C. and a pressure of 101325 Pa being 1.05 or more and 2.63 or less.

2. The lithium secondary battery according to claim 1, wherein the positive electrode layer is a plate-shaped electrode, and the negative electrode layer is a plate-shaped electrode.

3. The lithium secondary battery according to claim 1, wherein the solvent is a mixed liquid solvent containing a first substance that is an ester and has a carbonate, and a second substance that is an ester different from the first substance and has a carbonate or a lactone, and a volume ratio of the first substance to the second substance is within a range of 1:10 or more and 10:1 or less.

4. The lithium secondary battery according to claim 1, wherein the electrolyte is contained at a concentration of 2.0 mol/L or more and 8.0 mol/L or less.

5. The lithium secondary battery according to claim 1, further comprising an adhesive composed of a mixed resin of an acid-modified polyolefin resin and an epoxy resin, the adhesive bonding at least one of the positive electrode layer and the negative electrode layer to the exterior body within the closed space.

6. The lithium secondary battery according to claim 1, further comprising an adhesive composed of a mixed resin of an acid-modified polyolefin resin and an epoxy resin, the adhesive bonding at least one of the positive electrode layer and the negative electrode layer to the exterior body within the closed space, wherein the positive electrode layer is a plate-shaped electrode, the negative electrode layer is a plate-shaped electrode or a coated electrode, the solvent is a mixed solvent containing sulfolane and γ-butyrolactone, a volume ratio of the sulfolane to the γ-butyrolactone is 7:3 or more and 4:1 or less, and the electrolyte is contained at a concentration of 1.5 mol/L or more and 5.0 mol/L or less.

7. 7 The lithium secondary battery according to claim 2, wherein the solvent is a mixed liquid solvent containing a first substance that is an ester and has a carbonate, and a second substance that is an ester different from the first substance and has a carbonate or a lactone, and a volume ratio of the first substance to the second substance is within a range of 1:10 or more and 10:1 or less.

8. The lithium secondary battery according to claim 2, wherein the electrolyte is contained at a concentration of 2.0 mol/L or more and 8.0 mol/L or less.

9. The lithium secondary battery according to claim 2, further comprising an adhesive composed of a mixed resin of an acid-modified polyolefin resin and an epoxy resin, the adhesive bonding at least one of the positive electrode layer and the negative electrode layer to the exterior body within the closed space.
